(19) United States
(12) Patent Application Publication
(10) Pub. No.: US 2018/0190134 A1
(43) Pub. Date: Jul. 5, 2018

(54) COMPUTING SYSTEM AND METHOD FOR EFFICIENT KEYBOARD DATA ENTRY

(71) Applicant: Matthew William McInnis, Toronto (CA)

(72) Inventor: Matthew William McInnis, Toronto (CA)

(21) Appl. No.: 15/850,140

(22) Filed: Dec. 21, 2017

Related U.S. Application Data
(60) Provisional application No. 62/438,807, filed on Dec. 23, 2016.

(51) Int. Cl. G09B 5/02; G09B 13/00

(52) U.S. Cl. CPC G09B 5/02; G09B 13/00

(57) ABSTRACT

Provided herein is a computing system and a computer-implemented method for determining whether a user of a computer keyboard has hands in a predetermined position with respect to the computer keyboard. The method includes maintaining a data structure representing the predetermined position including an association between each of a plurality of fingers and a respective keyboard key; providing a prompt to the user to, while hands are located proximate the keyboard, depress a specified finger selected from the plurality of fingers; receiving an electronic signal from the keyboard pursuant to the prompt, the electronic signal representative of an activated keyboard key; comparing the activated keyboard key to the keyboard key that is associated in the data structure with the specified finger; and in the event that the activated keyboard key is the same as the keyboard key associated in the data structure with the specified finger, executing a first action, and otherwise, executing a second action that is different from the first action.

### CROSS REFERENCE TO RELATED APPLICATION

This application claims priority to U.S. provisional patent application Ser. No. 62/438,807 filed on Dec. 23, 2016, the contents of which are incorporated herein by reference in their entirety.

### FIELD OF THE INVENTION

The following relates generally to electronic data, data input and processing and more particularly to systems and methods for determining whether a user of a computer keyboard has hands in a predetermined position with respect to the computer keyboard.

### BACKGROUND OF THE INVENTION

The proliferation of personal computers and the incorporation of computer data entry in work environments brings a concomitant increase in the use of computer keyboards to enter data into computing systems. Such data may take the form of lines of software code, search strings, e-mails, creative writings and other kinds of data suitable for storage, processing and/or transmission by computers. Other methods of providing data to computers, such as voice data entry, are known and are increasing in use. However, “typing data in” using computer keyboards is expected to remain one of the most important and common modes by which data from a user is provided to a computing system.

Computer keyboards have a layout and structure derived from that of the typewriter, with rows of buttons for letters (such as ‘T’, ‘U’, and ‘V’), other characters (such as ‘?’ and ‘;’) and modifiers (such as SHIFT and TAB) placed in a particular common configuration. One such configuration is the above-mentioned QWERTY configuration, which derives its name from the individual letters in a top row of letters being ordered, from left to right, Q-W-E-R-T-Y. For a particular configuration, such as a QWERTY configuration, it is well-documented that placement of hands in a particular predetermined position with respect to the computer keyboard is very useful for promoting efficient data entry using the computer keyboard. For QWERTY keyboards it has long been argued that the most advantageous position is the home row position, such that when hands are not maintained in the home row position during typing activity the efficiency of data entry (measured primarily in terms of speed and error-rate/accuracy) is not as likely to be as high as when hands are maintained in the home row position.

The home row position, described in greater detail below and shown in FIG. 7, is believed to have been conceived of in 1888, and involves eight fingers in association with respective keyboard keys: “ASDF” for the “pinky,” fourth, third and index fingers, respectively, of the left hand, and “JKL;” for the index, second, third and fourth fingers, respectively, of the right hand. This position is so universally accepted that most conventional QWERTY keyboards have small bumps where index (i.e. “pointer”) fingers of the left and right hands should be positioned: namely, on the “F” and “J” keys respectively.

In the setting of a typical school classroom, human typing instructors verbally instruct their students to place their hands in a predetermined position with respect to the computer keyboard such as the home row position prior to beginning a lesson or a test. It is typical for the instructor to perform visual checks of students' hands during or before such a lesson or test and to provide feedback and reminders to the students about their hand positions.

An increasing number of students are now learning to proficiently type on computer keyboards with the help of software. Nearly all software packages for typing instruction that are known to the present inventor contain a direction to a student about hand placement, such as a direction to “place hands in the home row position,” prior to beginning a typing lesson.

While a reminder about computer keyboard hand placement can be useful, it is a challenge to determine whether in response a student's hands have been properly placed. An instruction issued by typing instruction software might request the student to press some or all of the home row position keys simultaneously, but difficulties arise from such approaches mainly because the student is still required to decide whether he or she has positioned his or her hands correctly. For the former example, the student could press an individual key using a “wrong” finger.

For the latter example in which the student may be instructed to press all of the home row keys simultaneously, hardware and software limitations of computer keyboards restrict transmission of all key press information that may be inherent in a student's simultaneous key presses. Each of these limits the extent to which the computing system can provide feedback on that student's actual hand position. One such hardware/software limitation of conventional computer keyboards is known as keyboard rollover. By way of explanation, FIG. 1 is an exploded perspective view of a printed circuit board and keyboard wiring matrix arrangement for a keyboard, according to the prior art as expressed in U.S. Pat. No. 3,592,759 to Comstock. Part of a similar matrix for a QWERTY-style keyboard is expressed logically in FIG. 2, showing a set of Rows R1 through R3 intersecting with a set of Columns C1 through C10. Pressing of a particular key on the computer keyboard causes an electrical signal corresponding to the associated row of the wiring matrix, and an electrical signal corresponding to the associated column of the wiring matrix, to be sent to microcontroller used for registering the row/column intersection and outputting a corresponding key code to a computing system with which the computer keyboard is associated. FIG. 3 is a top view of a printed circuit board having such a microcontroller that is typical of those contained within the conventional computer keyboard, showing a number of input pads that would be connected to respective column and row wires of a wiring matrix such as that shown in FIG. 2.

In general, the hardware wiring configuration of a conventional keyboard includes a wiring matrix built on physical switches underlying individual keys such that when a key is pressed, a switch is closed, and an electrical signal is registered by both a row and a column. Together, these signals are used by a microcontroller in the keyboard to determine which key was activated. This determination relies on interpreting circuits that change from an open state to a closed state when a corresponding key is pressed. As shown in FIG. 2, often multiple switches are connected to a single input of a microcontroller. This is unproblematic under normal typing circumstances because key presses for spelling words, for example, are done sequentially. However, for simultaneous key presses, ambiguity arises because the associated microcontroller, and correspondingly the computing system, cannot determine with certainty which or whether certain key presses occurred.

This deficiency is at least partly explained below with reference to FIGS. 4A through 4D, which are schematic diagrams of a portion of a wiring matrix of a computer keyboard in different respective states based on activation of particular keys of the computer keyboard. The portion of the wiring matrix represents rows R1 and R2, and Rm is shown as the “m^{th}” row in the wiring matrix. Similarly, the portion of the wiring matrix represents columns C1 and C2, and Cm is shown as the “m^{th}” column in the wiring matrix. In this example, keys for “Q”, “W”, “A” and “S” are illustrated as individual switches. The dotted lines in the diagrams show that there may be more than three rows and columns, though only three each are shown for ease of understanding.

In FIG. 4A, no keys are pressed such that no switches are physically closed and, as such, a corresponding microcontroller would not electrically register any keypresses. In FIG. 4B, the “Q” key is pressed such that signals from both row R1 and column C1 are sent to the corresponding microcontroller. The microcontroller would register such signals through a lookup table or other logical data structure using the tuple (R1, C1) as a key and would determine its corresponding character code from the data structure for sending to a computing system as an input for further processing or storage.

In FIG. 4C, both the “Q” and the “W” keys are pressed such that the signals from row R1 and both of columns C1 and C2 are sent to the microcontroller. The microcontroller could register such signals through the data structure using the tuple (R1, C1) as a key, along with the tuple (R1, C2) as another key and would determine corresponding character codes from the data structure for sending to the computing system.

In FIG. 4D, all three of the “Q”, “W” and “A” keys are pressed such that the signals from row R1 and both of columns C1 and C2 are sent to the microcontroller. The microcontroller would attempt to register such signals through a data structure using the tuples (R1, C1) and (R1, C2) as keys to the data structure, however, the microcontroller would not be able to further register that, additionally the “A” key was pressed. This is because the “A” would also produce a tuple of (R1, C1) just as did the “Q”.

Another limitation, relating to the Universal Serial Bus (USB) protocol particular to keyboards employing the USB protocol to convey data to the computing system, prevents a USB keyboard from actually transmitting eight simultaneous keypresses to a downstream computing system. The USB protocol is further limited in that it prevents a keyboard from transmitting six non-modifier keypresses. In computing, non-modifier keys are all keys that are not modifier keys (keys that temporarily modify the normal (i.e. unmodified) action of another key when pressed together, e.g. SHIFT, CTRL, COMMAND, OPTION, etc.). Such protocol transmission issues also persist for keyboards that connect wirelessly since the same communication protocols are used.

It would be useful to provide a more reliable means by which a computing system could help a user ensure his or her hands are at predetermined positions, such as a home row position, with respect to a computer keyboard.

### SUMMARY OF THE INVENTION

In accordance with an aspect, there is provided a computer-implemented method of determining whether a user of a computer keyboard has hands in a predetermined position with respect to the computer keyboard, the method comprising maintaining a data structure representing the predetermined position including an association between each of a plurality of fingers and a respective keyboard key; providing a prompt to the user to, while hands are located proximate the keyboard, depress a specified finger selected from the plurality of fingers; receiving an electronic signal from the keyboard pursuant to the prompt, the electronic signal representative of an activated keyboard key; comparing the activated keyboard key to the keyboard key that is associated in the data structure with the specified finger; and in the event that the activated keyboard key is the same as the keyboard key associated in the data structure with the specified finger, executing a first action, and otherwise, executing a second action that is different from the first action.

In an embodiment, the computer-implemented method further comprises performing the providing, receiving, comparing and executing steps multiple times, wherein during at least one of the times the specified finger for the prompt is on the left hand of the keyboard user and during at least one of the times the specified finger for the prompt is on the right hand of the keyboard user.

In an embodiment, one of the first and second actions comprises repeating the providing, receiving, comparing and executing steps with a different specified finger.

In an embodiment, the first action comprises determining whether to repeat the providing, receiving, comparing and executing steps with a different specified finger.

In an embodiment, determining whether to repeat comprises determining the proficiency of the keyboard user. In an embodiment, determining the proficiency comprises determining the historical proficiency of the keyboard user.

In an embodiment, determining whether to repeat comprises determining if the providing, receiving, comparing and executing steps have been executed a threshold number of times.

In an embodiment, the first action comprises displaying an indication of success. In an embodiment, the indication of success comprises enabling the user to conduct a different activity.

In an embodiment, the second action comprises displaying an indication of failure to the keyboard user. In an embodiment, the indication of failure is an additional prompt for a different specified finger.

In an embodiment, the predetermined position including an association between fingers and respective keyboard keys is reflective of the home row position of a QWERTY keyboard.

In an embodiment, prior to providing the prompt, an instruction is provided to the keyboard user to place the keyboard user's hands in the predetermined position.

In accordance with another aspect, there is provided a non-transitory computer readable medium embodying a computer program executable on a computing system for determining whether a user of a computer keyboard has hands in a predetermined position with respect to the computer keyboard, the computer program comprising computer program code for maintaining a data structure representing the predetermined position including an association between each of a plurality of fingers and a respective keyboard key; computer program code for providing a prompt to the user to, while hands are located proximate the keyboard, depress a specified finger selected from the plurality of fingers; computer program code for receiving an electronic signal from the keyboard pursuant to the prompt, the electronic signal representative of an activated keyboard key; computer program code for comparing the activated keyboard key to the keyboard key that is associated in the data structure with the specified finger; and computer program code for in the event that the activated keyboard key is the same as the keyboard key associated in the data structure with the specified finger, executing a first action, and otherwise, executing a second action that is different from the first action.

In accordance with another aspect, there is provided a computing system comprising processing structure configured to maintain an association between each of a plurality of fingers and a respective keyboard key of a keyboard and prompting a user of the keyboard to depress a specified finger selected from the plurality of fingers thereby to activate whichever keyboard key is proximate the specified finger, the processing structure pursuant to the prompting receiving an indication of an activated keyboard key from the keyboard and determining whether the activated keyboard key is the same as the keyboard key that is associated with the specified finger, wherein the processing structure selects an action to be executed based on the determining.

### BRIEF DESCRIPTION OF THE DRAWINGS

Embodiments of the invention will now be described with reference to the appended drawings in which:

FIG. 1 is an exploded perspective view of a printed circuit board and keyboard wiring matrix arrangement for a keyboard, according to the prior art;

FIG. 2 is a perspective top view of a conventional QWERTY computer keyboard and a logical matrix of rows and columns representing a wiring matrix, according to the prior art;

FIG. 3 is a top view of a printed circuit board typical of those contained within a conventional computer keyboard, according to the prior art;

FIGS. 4A through 4D are schematic diagrams of portions of a wiring matrix of a computer keyboard in different respective states based on activation of particular keys of the computer keyboard, according to the prior art;

FIG. 5 is a flowchart depicting steps in a method, according to an embodiment;

FIG. 6 is a schematic diagram of a computing system according to an embodiment;

FIG. 7 is a perspective top view of a conventional keyboard;

FIG. 8 is a perspective top view of a conventional keyboard and user's hands;

FIG. 9 is a visual flowchart depicting steps in a method with corresponding visual user prompts according to an embodiment; and

FIG. 10 shows various potential visual user prompts for use with embodiments of the present invention.

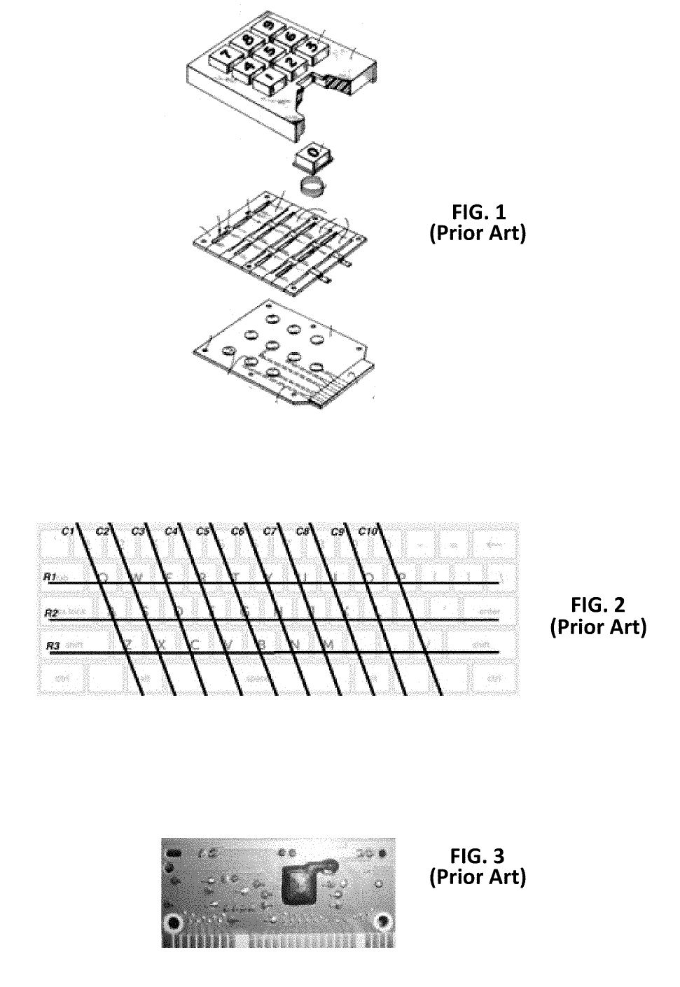

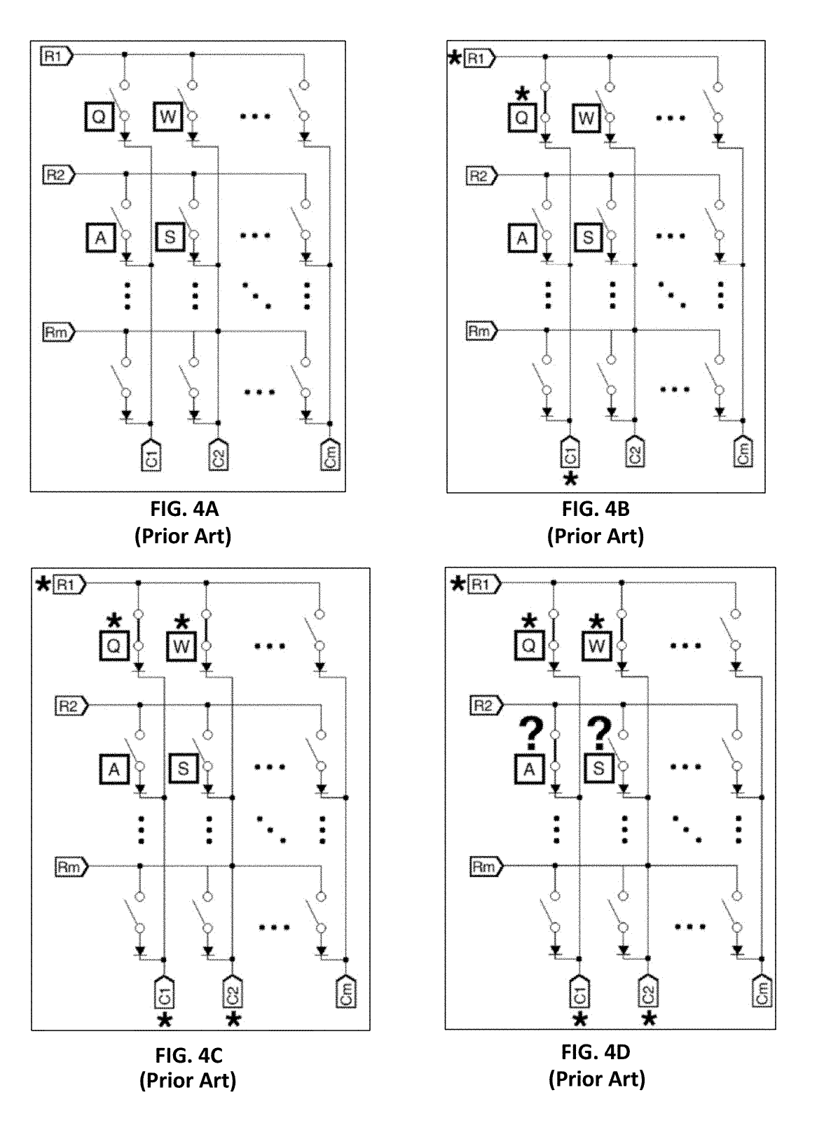

### DETAILED DESCRIPTION

The following relates to a computer-implemented method of determining whether a user of a computer keyboard has hands in a predetermined position with respect to the computer keyboard, and a computing system accordingly configured. The method comprises maintaining a data structure representing the predetermined position including an association between each of a plurality of fingers and a respective keyboard key. A prompt is provided to the user to, while hands are located proximate the keyboard, depress a specified finger selected from the plurality of fingers. An electronic signal is received from the keyboard pursuant to the prompt, the electronic signal representative of an activated keyboard key. The activated keyboard key is compared by the computer to the keyboard key that is associated in the data structure with the specified finger. In the event that the activated keyboard key is the same as the keyboard key associated in the data structure with the specified finger, a first action is executed. Otherwise, a second action that is different from the first action is executed.

Prompting the user to depress a particular finger (and thus, in turn, depress whatever keyboard key is beneath that particular finger at the time of the prompting), and receiving an electronic signal representative of an activated keyboard key, provide a useful advantage. The computing system can provide more reliable corrective feedback to the user than systems that more directly prompt the user to press a certain key or keys on the computer keyboard. This is because the wrong key (that is, a key not associated with the prompted finger in the data structure) would be pressed upon depressing the prompted finger if the user's hands were not in the predetermined position. On the other hand, the right key (that is, the key associated with the prompted finger in the data structure) would be pressed upon depressing the prompted finger if the user's hands were in the predetermined position.

Embodiments of the invention disclosed herein overcome two known hardware limitations in computer keyboards, namely keyboard rollover and transmission protocol limitations. In particular, by avoiding necessarily requiring simultaneous keypresses, unambiguous keypress information can be provided to the computing system for assessment.

Prompts may include one or a sequence of visual and/or auditory prompts referencing individual fingers (“finger cues”) to the user to press a keyboard key under a respective finger. This may be done in a random or pre-defined sequence in order to determine whether the user's fingers are in the proper starting position for efficient typing mechanics.

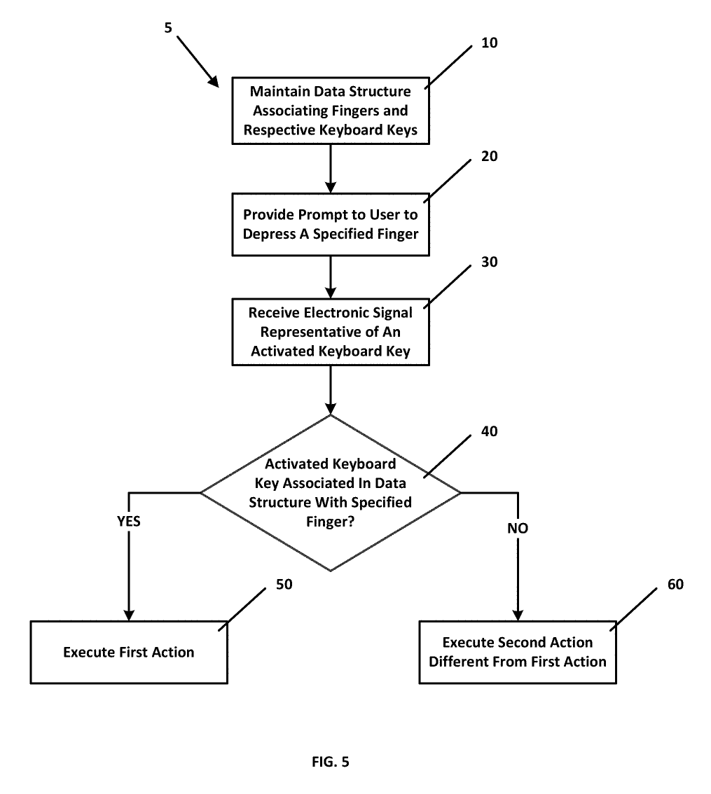

FIG. 5 is a flowchart depicting steps in a process 5 for determining whether a user of a computer keyboard has hands in a predetermined position with respect to the computer keyboard, according to an embodiment. In this embodiment, during process 5, a data structure associating fingers and respective keyboard keys is maintained (step 10). A prompt is provided to a user of the computer keyboard to depress a specified finger (step 20) and an electronic signal is received from the computer keyboard representative of an activated keyboard key (step 30). The activated keyboard key is then compared with the data structure to determine whether the activated keyboard key is associated in the data structure with the specified finger (step 40). In the event that the activated keyboard key is the same as the keyboard key associated in the data structure with the specified finger, a first action is executed (step 50). Otherwise, a second action that is different from the first action is executed (step 60).

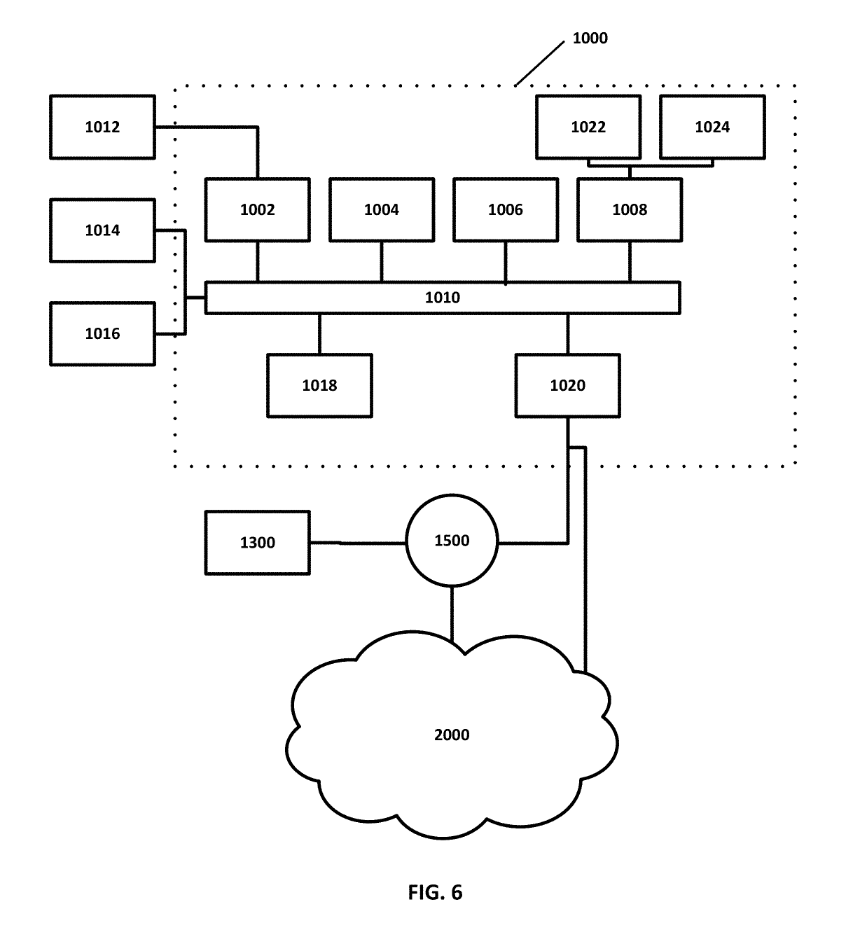

In this embodiment, process 5 is executed on one or more systems such as special purpose computing system 1000 shown in FIG. 6. Computing system 1000 may also be configured with software applications and hardware components to enable a user to author, edit and otherwise manipulate text material, to play media such as digital video encoded in various formats such as MP4, AVI, MOV, WEBM and according to various selected parameters, thereby to at least enable entry, manipulation and viewing of text and also to display text, video, sound or other kinds of instructions and/or feedback to a user of the computing system 1000.

Computing system 1000 includes a bus 1010 or other communication mechanism for communicating information, and a processor 1018 coupled with the bus 1010 for processing the information. The computing system 1000 also includes a main memory 1004, such as a random access memory (RAM) or other dynamic storage device (e.g., dynamic RAM (DRAM), static RAM (SRAM), and synchronous DRAM (SDRAM)), coupled to the bus 1010 for storing information and instructions to be executed by processor 1018. In addition, the main memory 1004 may be used for storing temporary variables or other intermediate information during the execution of instructions by the processor 1018. Processor 1018 may include memory structures such as registers for storing such temporary variables or other intermediate information during execution of instructions. The computing system 1000 further includes a read only memory (ROM) 1006 or other static storage device (e.g., programmable ROM (PROM), erasable PROM (EPROM), and electrically erasable PROM (EEPROM)) coupled to the bus 1010 for storing static information and instructions for the processor 1018.

The computing system 1000 also includes a disk controller 1008 coupled to the bus 1010 to control one or more storage devices for storing information and instructions, such as a magnetic hard disk 1022 and/or a solid state drive (SSD) and/or a flash drive, and a removable media drive 1024 (e.g., solid state drive such as USB key or external hard drive, floppy disk drive, read-only compact disc drive, read/write compact disc drive, compact disc jukebox, tape drive, and removable magneto-optical drive). The storage devices may be added to the computing system 1000 using an appropriate device interface (e.g., Serial ATA (SATA), peripheral component interconnect (PCI), small computing system interface (SCSI), integrated device electronics (IDE), enhanced-IDE (E-IDE), direct memory access (DMA), ultra-DMA, as well as cloud-based device interfaces).

The computing system 1000 may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)).

The computing system 1000 also includes a display controller 1002 coupled to the bus 1010 to control a display 1012, such as an LED (light emitting diode) screen, organic LED (OLED) screen, liquid crystal display (LCD) screen or some other device suitable for displaying information to a computer user. In an embodiment, display controller 1002 incorporates a dedicated graphics processing unit (GPU) for processing mainly graphics-intensive or other highly-parallel operations. Such operations may include rendering by applying texturing, shading and the like to wireframe objects including polygons such as spheres and cubes thereby to relieve processor 1018 of having to undertake such intensive operations at the expense of overall performance of computing system 1000. The GPU may incorporate dedicated graphics memory for storing data generated during its operations, and includes a frame buffer RAM memory for storing processing results as bitmaps to be used to activate pixels of display 1012. The GPU may be instructed to undertake various operations by applications running on computing system 1000 using a graphics-directed application programming interface (API) such as OpenGL, Direct3D and the like.

The computing system 1000 includes keyboard 1014 which can be any keyboard suitable for text and/or numerical entry and for which a home position or other predetermined hands position for efficient typing is applicable. Such computer keyboards could be wired or wireless keyboards, as well as integrated keyboards such as those provided as part of laptop computers. An example of a wireless keyboard is one available as part of the MK320 model “combo” keyboard and mouse package offered by Logitech International S.A. of Lausanne, Switzerland. The MK320 computer keyboard is a battery-operated QWERTY-style keyboard that interfaces wirelessly with a host computing system via a small USB interface dongle that is itself plugged into and powered via a wired USB port of a computer such as computing system 1000.

Other input devices include a pointing device 1016, for interacting with a computer user and providing information to the processor 1018. The pointing device 1016, for example, may be a mouse, a trackball, or a pointing stick for communicating direction information and command selections to the processor 1018 and for controlling cursor movement on the display 1012. The computing system 1000 may employ a display device that is coupled with an input device, such as a touch screen. Other input devices may be employed, such as those that provide data to the computing system via wires or wirelessly, such as gesture detectors including infrared detectors, gyroscopes, accelerometers, radar/sonar and the like. A printer may provide printed listings of data stored and/or generated by the computing system 1000.

The computing system 1000 performs a portion or all of the processing steps discussed herein in response to the processor 1018 and/or GPU of display controller 1002 executing one or more sequences of one or more instructions contained in a memory, such as the main memory 1004. Such instructions may be read into the main memory 1004 from another processor readable medium, such as a hard disk 1022 or a removable media drive 1024. One or more processors in a multi-processing arrangement such as computing system 1000 having both a central processing unit and one or more graphics processing unit may also be employed to execute the sequences of instructions contained in main memory 1004 or in dedicated graphics memory of the GPU. In alternative embodiments, hard-wired circuitry may be used in place of or in combination with software instructions.

As stated above, the computing system 1000 includes at least one processor readable medium or memory for holding instructions programmed according to the teachings of the invention and for containing data structures, tables, records, or other data described herein. Examples of processor readable media are solid state devices (SSD), flash-based drives, compact discs, hard disks, floppy disks, tape, magneto-optical disks, PROMs (EPROM, EEPROM, flash EPROM), DRAM, SRAM, SDRAM, or any other magnetic medium, compact discs (e.g., CD-ROM), or any other optical medium, punch cards, paper tape, or other physical medium with patterns of holes, a carrier wave (described below), or any other medium from which a computer can read.

Stored on any one or on a combination of processor readable media, is software for controlling the computing system 1000, for driving a device or devices to perform the functions discussed herein, and for enabling the computing system 1000 to interact with a human user (e.g., text author/editor). Such software may include, but is not limited to, device drivers, operating systems, development tools, and applications software. Such processor readable media further includes the computer program product for performing all or a portion (if processing is distributed) of the computer-implemented methods discussed herein.

The computer code devices discussed herein may be any interpretable or executable code mechanism, including but not limited to scripts, interpretable programs, dynamic link libraries (DLLs), Java classes, and complete executable programs. Moreover, parts of the processing of the present invention may be distributed for better performance, reliability, and/or cost.

A processor readable medium providing instructions to a processor 1018 may take many forms, including but not limited to, non-volatile media, volatile media, and transmission media. Non-volatile media includes, for example, optical, magnetic disks, and magneto-optical disks, such as the hard disk 1022 or the removable media drive 1024. Volatile media includes dynamic memory, such as the main memory 1004. Transmission media includes coaxial cables, copper wire and fiber optics, including the wires that make up the bus 1010. Transmission media also may also take the form of acoustic or light waves, such as those generated during radio wave and infrared data communications using various communications protocols.

Various forms of processor readable media may be involved in carrying out one or more sequences of one or more instructions to processor 1018 for execution. For example, the instructions may initially be carried on a magnetic disk of a remote computer. The remote computer can load the instructions for implementing all or a portion of the present invention remotely into a dynamic memory and send the instructions over a wired or wireless connection using a modem. A modem local to the computing system 1000 may receive the data via wired Ethernet or wirelessly via WiFi and place the data on the bus 1010. The bus 1010 carries the data to the main memory 1004, from which the processor 1018 retrieves and executes the instructions. The instructions received by the main memory 1004 may optionally be stored on storage device 1022 or 1024 either before or after execution by processor 1018.

The computing system 1000 also includes a communication interface 1020 coupled to the bus 1010. The communication interface 1020 provides a two-way data communication coupling to a network link that is connected to, for example, a local area network (LAN) 1500, or to another communications network 2000 such as the Internet. For example, the communication interface 1020 may be a network interface card to attach to any packet switched LAN. As another example, the communication interface 1020 may be an asymmetrical digital subscriber line (ADSL) card, an integrated services digital network (ISDN) card or a modem to provide a data communication connection to a corresponding type of communications line. Wireless links may also be implemented. In any such implementation, the communication interface 1020 sends and receives electrical, electromagnetic or optical signals that carry digital data streams representing various types of information.

The network link typically provides data communication through one or more networks to other data devices, including without limitation to enable the flow of electronic information. For example, the network link may provide a connection to another computer through a local network 1500 (e.g., a LAN) or through equipment operated by a service provider, which provides communication services through a communications network 2000. The local network 1500 and the communications network 2000 use, for example, electrical, electromagnetic, or optical signals that carry digital data streams, and the associated physical layer (e.g., CAT 5 cable, coaxial cable, optical fiber, etc). The signals through the various networks and the signals on the network link and through the communication interface 1020, which carry the digital data to and from the computing system 1000, may be implemented in baseband signals, or carrier wave based signals. The baseband signals convey the digital data as unmodulated electrical pulses that are descriptive of a stream of digital data bits, where the term “bits” is to be construed broadly to mean symbol, where each symbol conveys at least one or more information bits. The digital data may also be used to modulate a carrier wave, such as with amplitude, phase and/or frequency shift keyed signals that are propagated over a conductive media, or transmitted as electromagnetic waves through a propagation medium. Thus, the digital data may be sent as unmodulated baseband data through a “wired” communication channel and/or sent within a predetermined frequency band, different than baseband, by modulating a carrier wave. The computing system 1000 can transmit and receive data, including program code, through the network(s) 1500 and 2000, the network link and the communication interface 1020. Moreover, the network link may provide a connection through a LAN 1500 to a mobile device 1300 such as a personal digital assistant (PDA) laptop computer, or cellular telephone.

Electronic data such as the data structure described herein in connection with the invention can be an electronic representation of one or more of a table, an array, a database, a structured data file, an XML file, or some other functional data structure, stored in electronic storage such as main memory 1004, hard disk 1022, removable media 1024 or at least accessible to computing system 1000 despite being stored elsewhere.

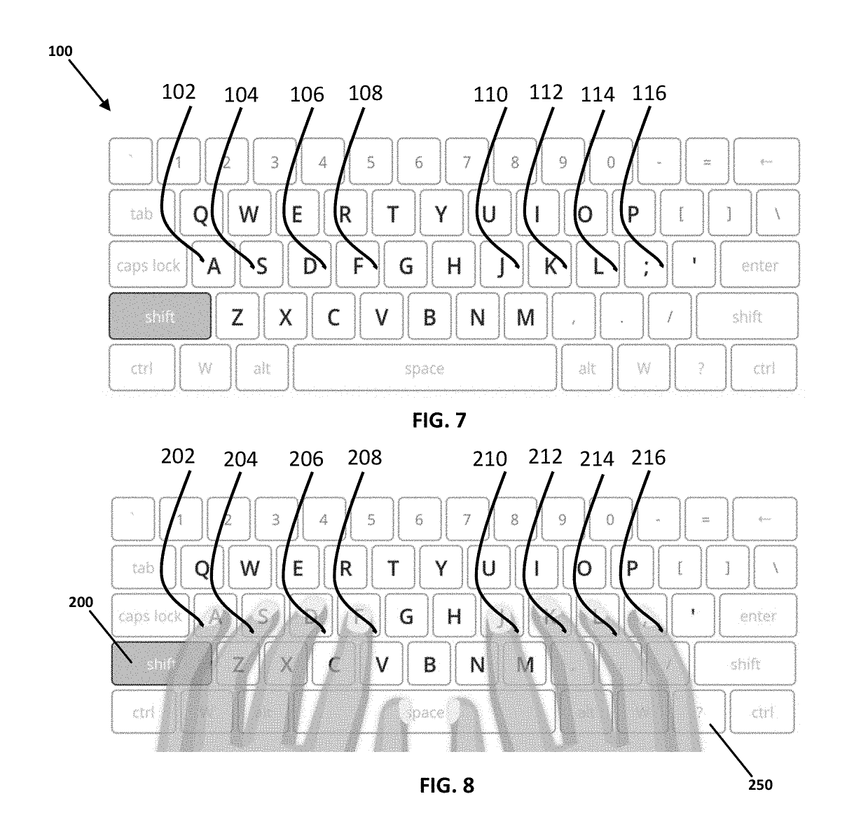

FIG. 7 is a perspective top view of a conventional QWERTY computer keyboard 100, as it would generally be seen by a user of the computer keyboard 100. FIG. 8 is a perspective top view of computer keyboard 100 with a computer keyboard user's hands 200 (left) and 250 (right) at a predetermined position. In this embodiment, the predetermined position corresponds to a position at which fingers are hovering above or are lightly in contact with the home row keys—namely, the home row position. In particular, the home row position of a QWERTY keyboard is typically said to consist of eight keys: an ‘A” key 102, an ‘S’ key 104, a ‘D’ key 106, an ‘F’ key 108 which are to be interacted with using respective fingers on the left hand 200 and a ‘J’ key 110, a ‘K’ key 112, an ‘L’ key 114, a ‘;’ key 116 which are to be interacted with using respective fingers on the right hand 250.

A mapping, or “association”, of fingers with particular individual keys is stored in a data structure within computing system 1000 so that it may be referenced during execution of embodiments of the method disclosed herein. The data structure is preferably stored at least in main memory 1004 so as to be readily accessible, and may alternatively or in combination be stored in hard disk 1022 or in some other data storage device to which computing system 1000 has ready and rapid access. In this embodiment, the data structure is an electronic table such as that shown in Table 1, below.

TABLE 1

| FINGER | FINGER | | INSTRUCTION | VISUAL DATA |
|---|---|---|---|---|
| ID | NAME | KEY | TEXT | FILE |
| 1 | Right Index | j | “Right Pointer | RI_large.jpg |
| | | | Finger” | |
| 2 | Right Middle | k | “Right Middle” | RM_large.jpg |
| | | | Finger | |
| 3 | Right Ring | l | “Right Ring | RR_large.jpg |
| | | | Finger” | |
| 4 | Right Pinky | ; | “Right Pinky | RP_large.jpg |
| | | | Finger” | |
| 5 | Left Pinky | a | “Left Pinky | LP_large.jpg |
| | | | Finger” | |
| 6 | Left Ring | s | “Left Ring | LR_large.jpg |
| | | | Finger” | |
| 7 | Left Middle | d | “Left Middle | LM_large.jpg |
| | | | Finger” | |
| 8 | Left Index | f | “Left Pointer | LI_large.jpg |
| | | | Finger” | |

In this embodiment, each finger is represented in the data structure using a unique FINGER ID. This is primarily for the purpose of maintaining unique record tracking in computing system 1000 and enabling updating of entire finger records by referencing the FINGER ID. A FINGER NAME is provided for ease of reference during implementation and may be different for different kinds of computer keyboards, such as those that may be more suited to users having physical handicaps or the like and that would be better served with a different prompting process than a person who has the use of all fingers on both hands. A KEY is provided in association with respective fingers in the FINGER NAME column, such that an electronic signal received from a computer keyboard that is representative of an activated key will be compared to the value represented in the KEY column. In this embodiment, while values in the KEY column are shown for illustration purposes as actual letters or characters, it will be understood that the KEY column may store ASCII (American Standard Code for Information Exchange) codes rather than the actual “j” or “k” characters. Alternatively the KEY column may store codes according to the schema of some other standard. The electronic signal received from the computer keyboard may be representative of the ASCII code or other code standard for, for example, ‘j’ or ‘k’, rather than actually being “j” or a ‘k’, for example. As an example, the ASCII code for ‘j’ is ‘106’ and the ASCII code for ‘k’ is ‘107’. The data stored in the first two rows of the KEY column in Table 1 above may be 106 and 107, respectively, binary equivalents of same. Alternatively, the data may be stored according to some other schema that permits effective translations to particular keys on the computer keyboard.

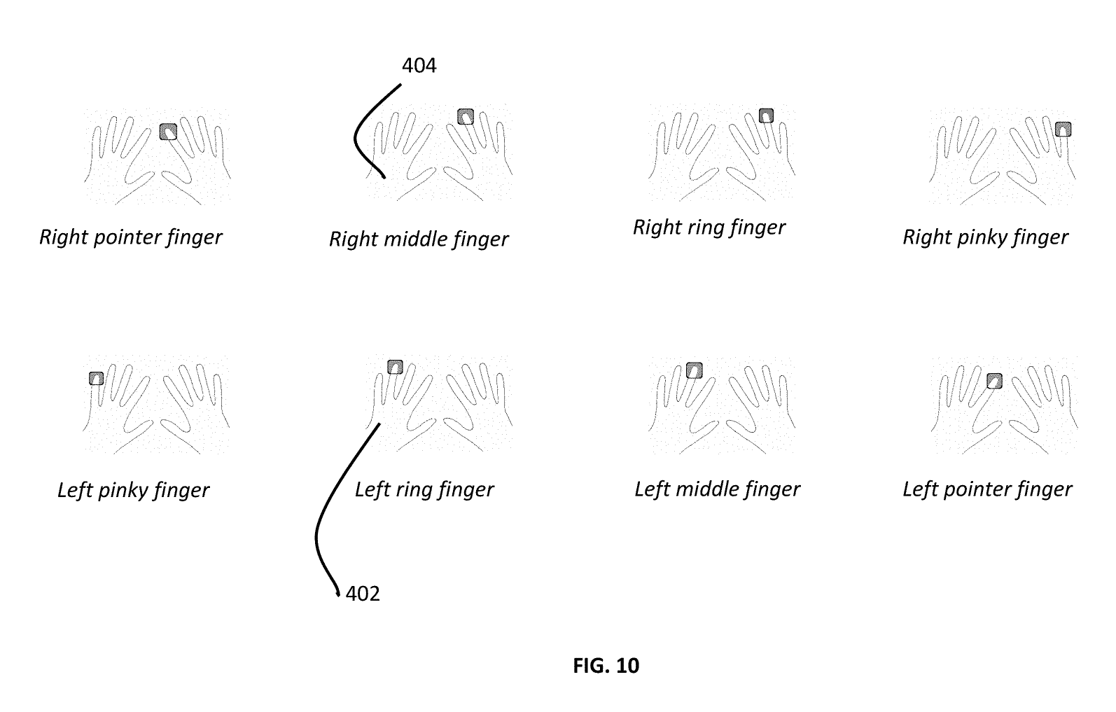

In this embodiment, the data structure further includes an INSTRUCTION TEXT column that may be referenced by computing system 1000 in order to aid with providing text prompting to a user. For example, considering the first row in Table 1, when prompting a user to press his or her Right Index finger so as to depress the keyboard key below the user's right index finger, the computing system may execute a routine that generates a text portion of the user prompt for display using the corresponding text in the INSTRUCTION TEXT column. For example, the corresponding text could be “Right Pointer Finger”, as shown by example in FIG. 10. In this embodiment, the data structure further includes a VISUAL DATA FILE column that may be referenced by computing system 1000 in order to aid with providing visual prompting to a user. For example, considering the first row in Table 1, when prompting a user to press his or her Right Index finger so as to depress the keyboard key below the user's right index finger, the computing system may execute a routine that displays a pictorial portion of the user prompt using a file referenced by the file name in the VISUAL DATA FILE column, as also shown in FIG. 10.

As represented visually in FIG. 8, the finger-key pairings for a home row position are stored in the data structure represented in Table 1 as follows: a left pinky finger 202 is to interact with (and is therefore associated with) the “A” key 102, a left ring finger 204 is to interact with (and is therefore associated with) the ‘S’ key 104, a left middle finger 206 is to interact with (and is therefore associated with) the ‘D’ key 106, a left pointer (index) finger 208 is to interact with (and is therefore associated with) the ‘F’ key 108, a right pointer (index) finger 210 is to interact with (and is therefore associated with) the ‘J’ key, a right middle finger 212 is to interact with (and is therefore associated with) the ‘K’ key 112, a right ring finger 214 is to interact with (and is therefore associated with) the ‘L’ key 114, and a right pinky finger 216 is to interact with (and is therefore associated with) the ‘;’ key 116.

It will be understood that in alternative embodiments other predetermined positions, such as home row positions for non-QWERTY keyboards, may specify different keys for respective fingers.

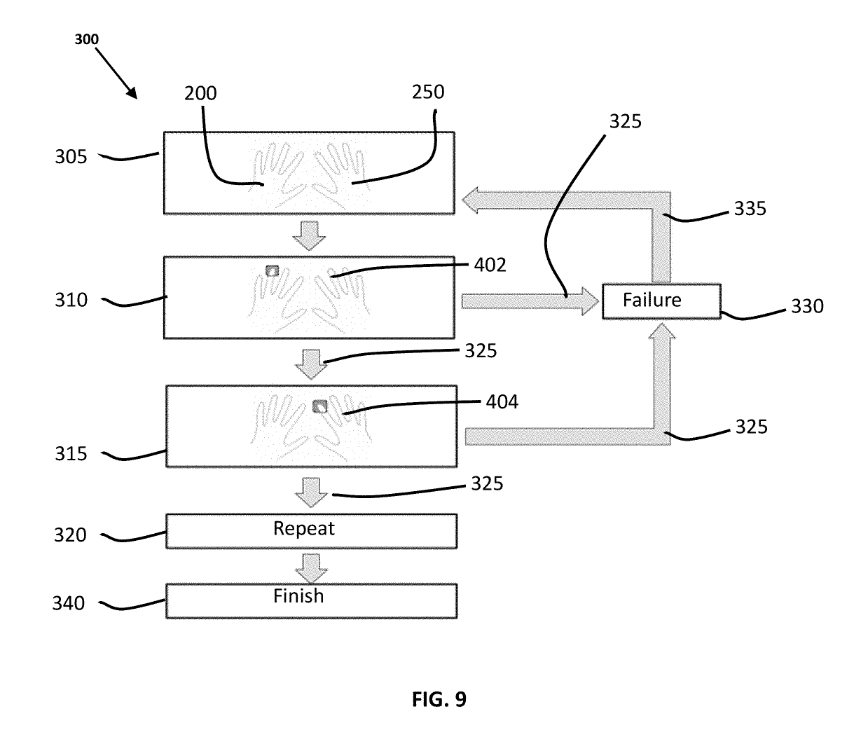

FIG. 9 is a visual flowchart depicting steps in a method 300 with corresponding visual user prompts according to an embodiment. Method 300 may be executed to help determine the position of the user's hands, compare this position to the proper hand position, and optionally provide a remedial indication to the user. At step 305, the user begins a typing instruction routine and places his or her left and right hands 205, 250 near to or lightly upon a computer keyboard such as computer keyboard 1014. Additionally, an introductory prompt may be conveyed to the user: “Place your hands on the keyboard in the Home Row position”.

At step 310, the user is provided with a visual prompt instructing the user to press a specified finger. The specified finger in the instruction may be chosen at random or be selected from a predefined sequence. For example, the specified finger may be the left ring finger such that the left ring finger visual prompt 402 corresponding to FINGER ID ‘6’ and associated with KEY ‘s’ as shown in Table 1 is selected. This visual prompt, which involves display of the graphic file “LR_large.jpg” on the display 1021 of computing system 1000, may be accompanied by a text prompt such as “Left Ring Finger” as described above. However, it should be noted that, in this embodiment the user is not actually prompted to press the ‘s’ key. Rather, the user is prompted only to press the “Left Ring Finger” and the user is not told which actual key to press. In this way, the position at which the user's hands are presently located is determined, instead of the user's ability to depress the ‘s’ key in response to the prompt. It will be understood that a displayed graphic file may itself incorporate text.

FIG. 10 shows various potential visual text and pictorial prompts for use with embodiments of the present invention. The computing system 1000, being aware that it has prompted the user to press a finger that should result in a particular (correct) keypress if the user's hands are in the home row position and should result in some other (incorrect) keypress if the user's hands are not in the home row position, receives an electronic signal from the computer keyboard pursuant to the prompt. Computing system 1000 conducts a comparison between the key the electronic signal represents and the KEY in the corresponding row of Table 1. In the event that the electronic signal representing the key pressed on the computer keyboard does not correspond to the value in the KEY column that is in the FINGER ID ‘6’ row, the computing system advances at 335 to register a Failure (step 330) and, in this embodiment, advances at 335 to return to displaying a prompt for the user to put his or her hands in the home row position. The action to provide this particular prompt may be considered an indication of failure. Other indications of failure are possible, such a displaying a different colour graphic or playing back a particular audio indication such as a buzzer sound.

On the other hand, in the event that the electronic signal representing one of the keys pressed on the computer keyboard does in fact correspond to the value in the KEY column that is in the FINGER ID ‘6’ row (namely, the ‘s’ key in this embodiment), the computing system registers a success and, in this embodiment, then advances to provide another prompt that indicates success with the keypress. Alternatively or in some combination another indication of success may be provided, such as displaying a different colour graphic or playing back a particular audio indication such as a pleasant bell sound. At step 315, the user is provided with a visual prompt instructing the user to press another specified finger, chosen at random or from a predefined sequence, for example the right index visual prompt 404 corresponding to FINGER ID ‘1’ and associated KEY ‘j’ as shown in Table 1. This visual prompt, which involves display of the graphic file “RI_large.jpg” on the display 1021 of computing system 1000, may be accompanied by a text prompt such as “Right Pointer Finger” as described above. However, in this embodiment the user is not actually prompted to press the ‘j’ key—only to press the “Right Pointer Finger”; the user is not told which actual key to press. In this way, the position at which the user's hands are presently located is determined, instead of the user's ability to depress the ‘j’ key in response to the prompt. It will be understood that a displayed graphic file may itself incorporate text.

Again, the computing system 1000, being aware that it has prompted the user to press a finger that should result in a particular (correct) keypress if the user's hands are in the home row position and should result in some other (incorrect) keypress if the user's hands are not in the home row position, receives an electronic signal from the computer keyboard pursuant to the prompt. Computing system 1000 conducts a comparison between the key the electronic signal represents and the KEY in the corresponding row of Table 1. In the event that the electronic signal representing the key pressed on the computer keyboard does not correspond to the value in the KEY column that is in the FINGER ID ‘1’ row, the computing system advances 325 to register a Failure (step 330) and, in this embodiment, advances at 335 to return to displaying a prompt for the user to put his or her hands in the home row position.

On the other hand, in the event that the electronic signal representing one of the keys pressed on the computer keyboard does in fact correspond to the value in the KEY column that is in the FINGER ID ‘1’ row (namely, the ‘j’ key in this embodiment), the computing system registers a success and, in this embodiment, then advances at 325 to Repeat the prompting 320 or to Finish the prompting 340 to advance to a lesson, to a test, or to some other phase. The number of Repeats may be predetermined, or may be based on one or more other factors, such as user typing proficiency.

As users improve their typing speed and accuracy, they are likely to become less in need of technique reinforcement. As such, as part of a software application for typing instructions that provides prompts and feedback for helping a user maintain a home row position and tracks historical progress (improvements in speed and/or accuracy over time or absolute measures of same) and proficiency of each user, a routine for determining whether a user of a computer keyboard has hands in a predetermined position with respect to the computer keyboard may be done less and less often as the user progresses beyond certain proficiency milestones.

Longer and shorter sequences of prompts may be provided for users based on proficiency or individual tendencies to stray from initially being at a home row position. For example, a short sequences might tend to be more appropriate for more proficient typists who, once prompted, are more likely to gravitate to the correct home position. Longer sequences, such as might be appropriate for a less proficient typist, are possible.

For a proficient typist, a single pair of prompts to depress one finger on each hand may be appropriate. On the other hand, a beginner typist may be prompted several additional times.

While embodiments have been described, alternatives are possible.

What is claimed is:

1. A computer-implemented method of determining whether a user of a computer keyboard has hands in a predetermined position with respect to the computer keyboard, the method comprising:
maintaining a data structure representing the predetermined position including an association between each of a plurality of fingers and a respective keyboard key;
providing a prompt to the user to, while hands are located proximate the keyboard, depress a specified finger selected from the plurality of fingers;
receiving an electronic signal from the keyboard pursuant to the prompt, the electronic signal representative of an activated keyboard key;
comparing the activated keyboard key to the keyboard key that is associated in the data structure with the specified finger; and
in the event that the activated keyboard key is the same as the keyboard key associated in the data structure with the specified finger, executing a first action, and otherwise, executing a second action that is different from the first action.

2. The computer-implemented method of claim 1, further comprising:
performing the providing, receiving, comparing and executing steps multiple times, wherein during at least one of the times the specified finger for the prompt is on the left hand of the keyboard user and during at least one of the times the specified finger for the prompt is on the right hand of the keyboard user.

3. The computer-implemented method of claim 1, wherein one of the first and second actions comprises repeating the providing, receiving, comparing and executing steps with a different specified finger.

4. The computer-implemented method of claim 1, wherein the first action comprises determining whether to repeat the providing, receiving, comparing and executing steps with a different specified finger.

5. The computer-implemented method of claim 4, wherein determining whether to repeat comprises:
determining the proficiency of the keyboard user.

6. The computer-implemented method of claim 5, wherein determining the proficiency comprises:
determining the historical proficiency of the keyboard user.

7. The computer-implemented method of claim 4, wherein determining whether to repeat comprises determining if the providing, receiving, comparing and executing steps have been executed a threshold number of times.

8. The computer-implemented method of claim 1, wherein the first action comprises displaying an indication of success.

9. The computer-implemented method of claim 8, wherein the indication of success comprises enabling the user to conduct a different activity.

10. The computer-implemented method of claim 1, wherein the second action comprises displaying an indication of failure to the keyboard user.

11. The computer-implemented method of claim 1, wherein the predetermined position including an association between fingers and respective keyboard keys is reflective of the home row position of a QWERTY keyboard.

12. The computer-implemented method of claim 1, further comprising:
prior to providing the prompt, providing an instruction to the keyboard user to place the keyboard user's hands in the predetermined position.

13. A non-transitory computer readable medium embodying a computer program executable on a computing system for determining whether a user of a computer keyboard has hands in a predetermined position with respect to the computer keyboard, the computer program comprising:
computer program code for maintaining a data structure representing the predetermined position including an association between each of a plurality of fingers and a respective keyboard key;
computer program code for providing a prompt to the user to, while hands are located proximate the keyboard, depress a specified finger selected from the plurality of fingers;
computer program code for receiving an electronic signal from the keyboard pursuant to the prompt, the electronic signal representative of an activated keyboard key;
computer program code for comparing the activated keyboard key to the keyboard key that is associated in the data structure with the specified finger; and
computer program code for in the event that the activated keyboard key is the same as the keyboard key associated in the data structure with the specified finger, executing a first action, and otherwise, executing a second action that is different from the first action.

14. The computer-implemented method of claim 13, further comprising:
computer program code for performing the providing, receiving, comparing and executing steps multiple times, wherein during at least one of the times the specified finger for the prompt is on the left hand of the keyboard user and during at least one of the times the specified finger for the prompt is on the right hand of the keyboard user.

15. The computer-implemented method of claim 13, wherein one of the first and second actions comprises repeating the providing, receiving, comparing and executing steps with a different specified finger.

16. The computer-implemented method of claim 13, wherein the first action comprises determining whether to repeat the providing, receiving, comparing and executing steps with a different specified finger.

17. The computer-implemented method of claim 16, wherein determining whether to repeat comprises:
determining the proficiency of the keyboard user.

18. The computer-implemented method of claim 17, wherein determining the proficiency comprises:
determining the historical proficiency of the keyboard user.

19. The computer-implemented method of claim 16, wherein determining whether to repeat comprises determining if the providing, receiving, comparing and executing steps have been executed a threshold number of times.

20. The computer-implemented method of claim 13, wherein the first action comprises displaying an indication of success.

21. The computer-implemented method of claim 20, wherein the indication of success comprises enabling the user to conduct a different activity.

22. The computer-implemented method of claim 13, wherein the second action comprises displaying an indication of failure to the keyboard user.

23. The computer-implemented method of claim 13, wherein the predetermined position including an association between fingers and respective keyboard keys is reflective of the home row position of a QWERTY keyboard.

24. The computer-implemented method of claim 13, further comprising:
computer program code for, prior to providing the prompt, providing an instruction to the keyboard user to place the keyboard user's hands in the predetermined position.

25. A computing system comprising:
a keyboard;
a display device;
processing structure in operative communication with the keyboard and the display device, the processing structure arranged to execute a method of determining whether a user of a computer keyboard has hands in a predetermined position with respect to the computer keyboard, the method comprising:
maintaining a data structure representing a predetermined position with respect to the keyboard including an association between each of a plurality of fingers and a respective keyboard key;
providing a prompt via the display to the keyboard user to, while hands are located proximate the keyboard, depress a specified finger selected from the plurality of fingers;
receiving an electronic signal from the keyboard pursuant to the prompt, the electronic signal representative of an activated keyboard key;
comparing the activated keyboard key to the keyboard key that is associated in the data structure with the specified finger;
in the event that the activated keyboard key is the same as the keyboard key associated in the data structure with the specified finger, executing a first action, and otherwise, executing a second action that is different from the first action.

26. A computing system comprising processing structure configured to maintain an association between each of a plurality of fingers and a respective keyboard key of a keyboard and prompting a user of the keyboard to depress a specified finger selected from the plurality of fingers thereby to activate whichever keyboard key is proximate the specified finger, the processing structure pursuant to the prompting receiving an indication of an activated keyboard key from the keyboard and determining whether the activated keyboard key is the same as the keyboard key that is associated with the specified finger, wherein the processing structure selects an action to be executed based on the determining.
